(19) United States
(12) Patent Application Publication
(10) Pub. No.: US 2004/0002050 A1
(43) Pub. Date: Jan. 1, 2004

(54) Professional coaching process and tool for use in an online education system

(75) Inventors: Mary Kay Wagner, St. Paul, MN (US); Samuel Turner Tutterow, Minneapolis, MN (US); David Marlyn Gilbert, Minneapolis, MN (US); Shelley Ruth Robbins, North Oaks, MN (US); Stephen Walker Scofield, Minneapolis, MN (US); Jeffrey William Staggs, Mound, MN (US); Barbara Butts Williams, Minneapolis, MN (US)

Correspondence Address: FAEGRE & BENSON LLP, 2200 Wells Fargo Center, 90 South Seventh Street, Minneapolis, MN, 55402-3901, US

(73) Assignee: Capella Education Company

(21) Appl. No.: 10/429,186

(22) Filed: May 2, 2003

Related U.S. Application Data
(60) Provisional application No. 60/377,141, filed on May 2, 2002.

(51) Int. Cl. G09B 7/00

(52) U.S. Cl. 434/362

(57) ABSTRACT

A method for providing professional coaching to a learner in connection with an online academic program. Course web pages are provided in connection with the online academic program. The course web pages links to a personal information web page for the learner to record his or her personal information through use of Internet-based communications. The method further includes the step of assisting the learner to establish a professional coaching relationship through use of the Internet-based communications. One or more virtual coaching sessions are provided to the learner during the academic program.

### CROSS REFERENCE TO RELATED APPLICATION

This application claims the benefit of U.S. Provisional Application Serial No. 60/377,141 filed May 2, 2002, which is hereby incorporated by reference in its entirety.

### FIELD OF THE INVENTION

The present invention relates generally to an online education system. More particularly, the present invention is a method and system for providing professional coaching to a learner in connection with an online academic program offered by an educational institution.

### BACKGROUND OF THE INVENTION

The Internet has been used in association with traditional classroom oriented teaching and nontraditional online teaching. The Internet, for example, allows learners to view and listen to pre-recorded classes via a web browser. In addition, the Internet not only allows the learners to participate in virtual classroom discussions, but also allows the learners to ask faculty members questions and submit homework assignments electronically. However, the full potential of the Internet as an educational tool is yet to be harnessed.

### SUMMARY OF THE INVENTION

The present invention provides learners with a virtual professional coaching environment through use of Internet-based communications. The present invention provides a method for offering professional coaching to the learner in connection with an online academic program. In one embodiment of the invention, course web pages are provided in connection with the online academic program. The course web pages links to a personal information web page for the learner to record his or her personal information through use of the Internet-based communications. The method further includes the step of assisting the learner to establish a professional coaching relationship through use of the Internet-based communications. One or more virtual coaching sessions are provided to the learner during the academic program.

### BRIEF DESCRIPTION OF THE DRAWINGS

FIG. 1 is a block diagram of an online education system with a virtual professional coaching environment in accordance with the present invention.

FIG. 2 is a flow chart illustrating the principal steps of a method for a learner to obtain professional coaching in accordance with the present invention.

FIGS. 3a and 3b are screen views that illustrate example web pages of an online course.

FIG. 4a is a screen view that illustrates a “Coaching Center” main page through which a learner can access personal information pages.

FIG. 4b is a screen view that illustrates a “Getting Started” web page.

FIG. 5 is a screen view that illustrates an example of a web page through which a learner can record his or her personal values and purposes.

FIG. 6 is a screen view that illustrates an example of a web page through which a learner can record his or her personal vision.

FIG. 7 is a screen view that illustrates an example of a web page through which a learner can conduct self-assessments.

FIG. 8 is a screen view that illustrates an example of a web page through which a learner can conduct an analysis on his or her strengths, weaknesses, opportunities, and threats.

FIG. 9 is a screen view that illustrates an example of a web page through which a learner can record a statement of stretch, impact, and reposition, his or her personal goals, and a personal learning plan.

FIG. 10 is a screen view that illustrates an example of a “Choose Your Coach” main page through which the learner can access a coach biography web page and choose a professional coach.

FIG. 11 is a screen view that illustrates an example of a coach biography web page.

FIG. 12 is a screen view that illustrates an example of a web page through which a learner can choose a professional coach.

### DETAILED DESCRIPTION OF THE INVENTION

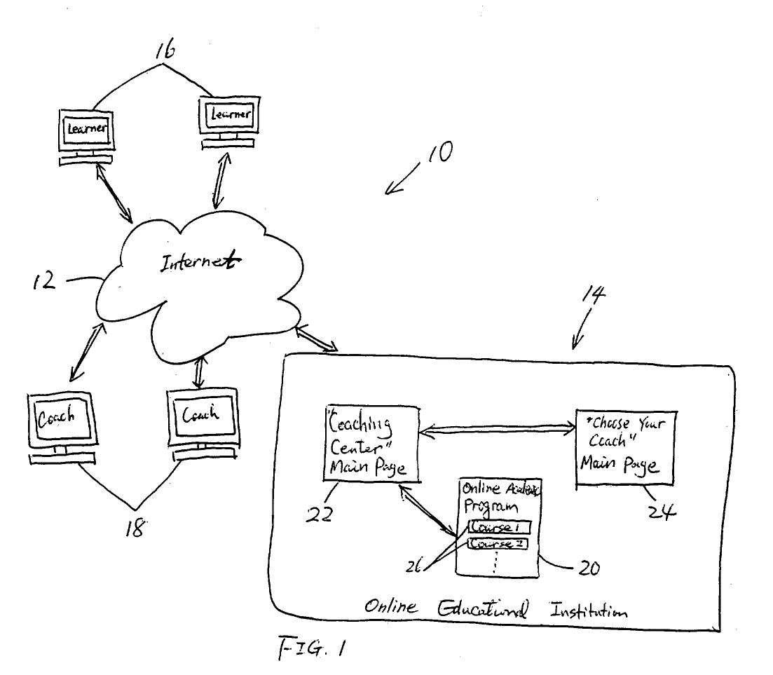

The professional coaching system of the present invention provides learners with a virtual professional coaching environment in connection with an online academic program offered by an educational institution. FIG. 1 is a block diagram of an online education system 10 with a virtual professional coaching environment in accordance with the present invention. The online education system 10 is divided into four sections: an Internet interface 12, an online educational institution 14, learners 16, and professional coaches 18. The sections 12, 14, 16, and 18 are typically separated from one another by firewalls and routers to prevent unauthorized access.

The learners 16 and the professional coaches 18 can access the online educational institution 14 over the Internet via web-enabled devices, such as personal computers. The online educational institution 14 contains servers, programs, and systems that comprise an online learning environment. In accordance with the present invention, the online educational institution 14 includes at least one online academic program 20 comprised of a plurality of online courses 26, a “Coaching Center” main page 22, and a “Choose Your Coach” main page 24. Both the “Coaching Center” main page 22 and the “Choose Your Coach” main page 24 are used by the learners 16 in connection with the online courses 26 of the online academic program 20. Through the “Coaching Center” main page 22, the learner 16 can access a plurality of personal information web pages to record his or her personal information relating to professional development and/or study of the academic program. The “Coaching Center” main page 22 contains a link to the “Choose Your Coach” main page 24. Through the “Choose Your Coach” main page, the learner 16 can access coach biography web pages and choose a professional coach. The learner 16 and the coaches 18 can communicate with each other through use of the Internet-based communications.

The virtual professional coaching environment is described herein in connection with an exemplary online Master of Business Administration (MBA) program offered by Capella University. However, it will be evident to those skilled in the art that the method and system can be used with other online academic programs.

It is noted that while the present invention provides implementation of the professional coaching process within an Internet-based system, the coaching process need not be provided through use of the Internet. Instead, one of reasonable skill in the art will appreciate that the professional coaching process may be implemented within other mediums, including, but not limited to, a local area network.

Initially, a learner applies for admission to the online MBA program. After reviewing the application materials submitted by the learner, the admissions committee admits the learner to the program if the learner meets or exceeds the admission requirements.

The online MBA program offered by Capella University includes two foundation courses, seven core business courses that deliver the classic MBA disciplines, six professional effectiveness core courses that deliver the best practices of effective corporate managers, and a final capstone course. All of the courses are conducted online through use of Internet-based communications.

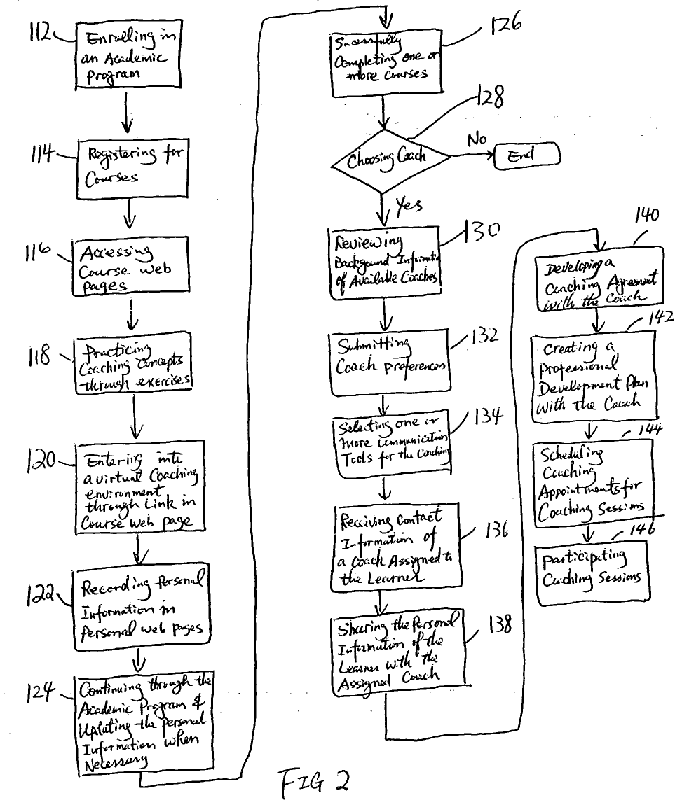

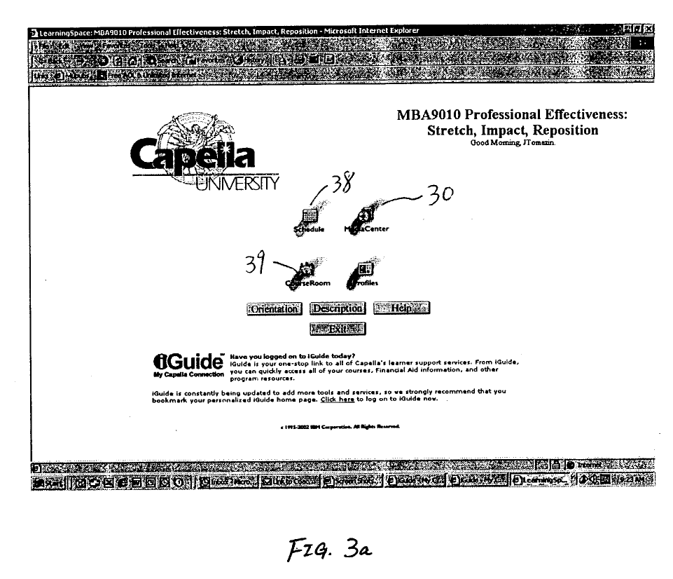

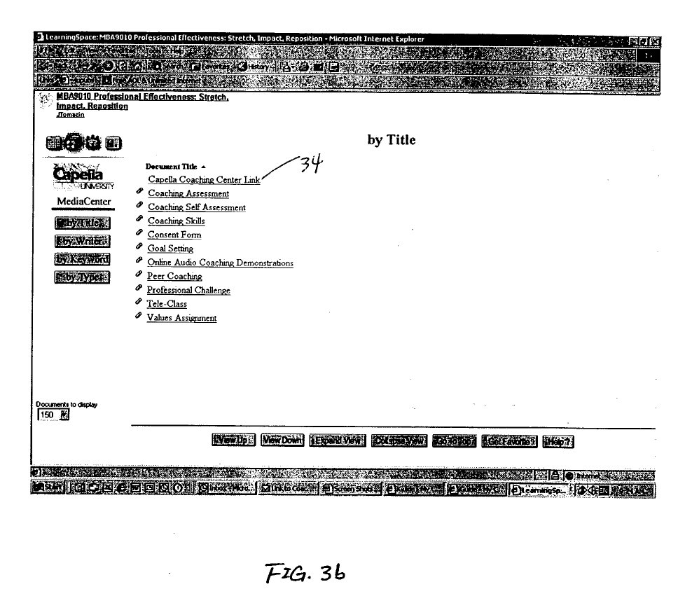

FIG. 2 is a flow chart illustrating the principal steps of the method for a learner to obtain professional coaching in accordance with the present invention. As indicated in blocks 112 and 114 of FIG. 2, the learner enrolls in the MBA program and registers for one or more foundation courses (e.g., the first and second foundation courses) through use of the Internet-based communications. The learner then starts to take the foundation courses online by accessing course web pages as indicated in block 116 of FIG. 2. FIGS. 3a and 3b are screen views that illustrate example web pages of the first foundation course. From the course web page as shown in FIG. 3a, the learner can access an online course schedule and an online classroom by clicking the “Schedule” icon 38 and the “CourseRoom” icon 39, respectively.

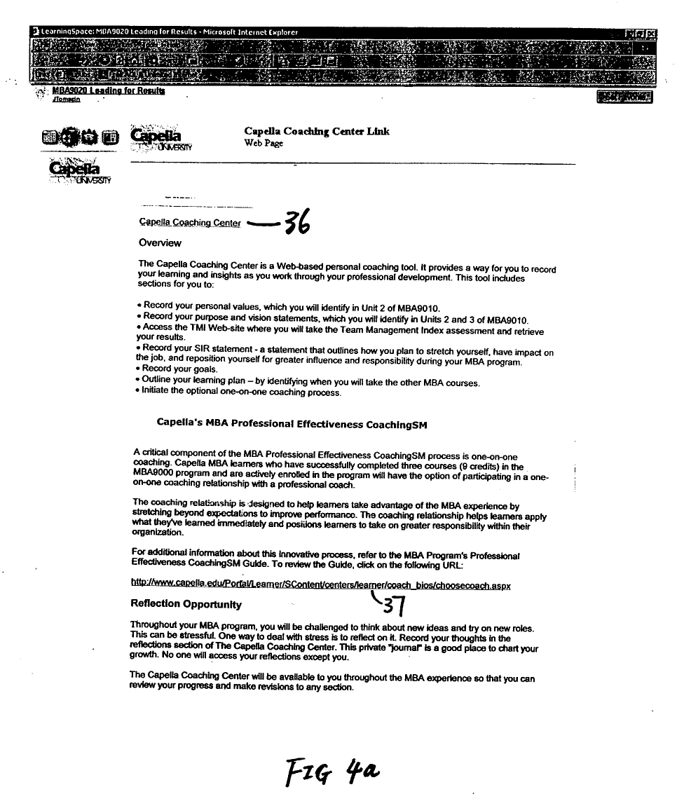

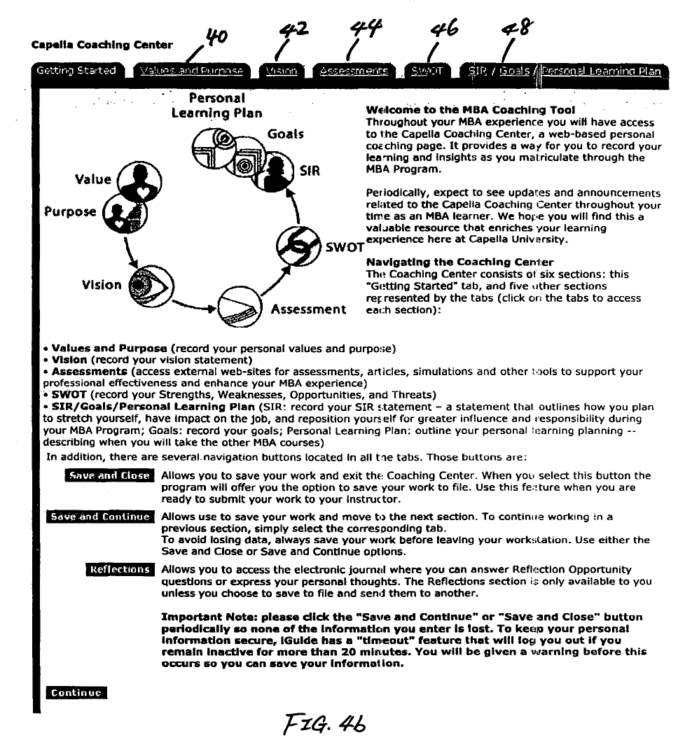

After the learner starts the foundation courses, he or she begins to prepare for upcoming virtual coaching sessions. According to the foundation course syllabus, the learner is instructed to practice professional coaching concepts through exercises as indicated in block 118 of FIG. 2. The learner enters into a virtual coaching environment by opening a link in the course web page as indicated in block 120 of FIG. 2. The learner can access an online media center as shown in FIG. 3b by clicking the “MediaCenter” icon 30 in the course web page as shown in FIG. 3a. By clicking the “Capella Coaching Center Link” 34 in FIG. 3b, the learner can open the “Coaching Center” main page as shown in FIG. 4a. The “Coaching Center” main page includes an overview of the professional coaching. The main page also contains a link 36 to “Capella Coaching Center,” which includes a “Getting Started” web page and a plurality of personal information pages. As shown in FIG. 4b, the “Getting Started” web page contains general information of the “Coaching Center.” From the “Getting Started” page, the learner can open different personal information pages to record his or her personal information relating to both professional development in his or her career and study of the MBA program as instructed by the foundation course syllabus.

As shown in FIG. 4b, the “Capella Coaching Center” includes five tabs 40, 42, 44, 46, and 48 linking to five different personal information pages. The personal information pages includes a “Values and Purpose” page, a “Vision” page, an “Assessments” page, a “Strengths, Weaknesses, Opportunities, and Threats (SWOT)” page, and a “Stretch, Impact, and Reposition (SIR)/Goals/Personal Learning Plan” page. As indicated in block 122 of FIG. 2, the learner records his or her personal information in these personal information pages.

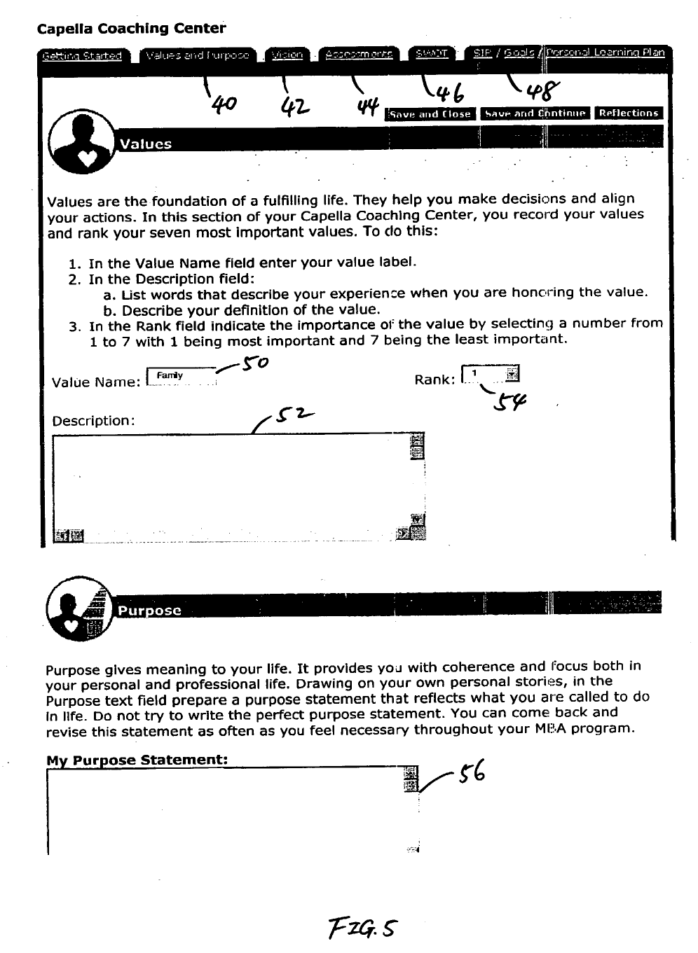

FIG. 5 is a screen view that illustrates the “Values and Purpose” web page through which a learner can record his or her personal values and purposes. The “Values and Purpose” web page can be accessed through clicking the “Values and Purpose” tab 42 in the “Capella Coaching Center”. The personal values help the learner make decisions and align actions in his or her personal and professional life. Once the learner is clear about the values, he or she can make career choices that are consistent with what is most important to him or her. For example, being aware of his or her personal values, the learner can decide what area of an organization to work in, and make choices about what he or she will and will not do in the organization as well. When the learner is uncomfortable in a situation, he or she can determine the source of discomfort by reflecting on what value is being violated. The options for handling the discomfort then become more evident.

The learner initially enters a value label in the “Value Name” text field 50, and then describes his or her experience when he or she is honoring the value in the “Description” text field 52. The learner further ranks the value that he or she entered in the “Rank” combo box 54. The importance of the value is ranked by selecting a number from 1 to 7 with 1 being most important and 7 being the least important. Preferably, the web page includes three or more sets of data entry fields containing the “Value Name” text field, the “Description” text field, and the “Rank” combo box. It is important for the learner to acknowledge and record all of his or her personal values.

While values are the foundation for a fulfilling life, purpose gives a life direction. In other words, identifying the purpose provides a path for the life of the learner. As illustrated in FIG. 5, the learner records a purpose statement in “My Purpose Statement” text field 56.

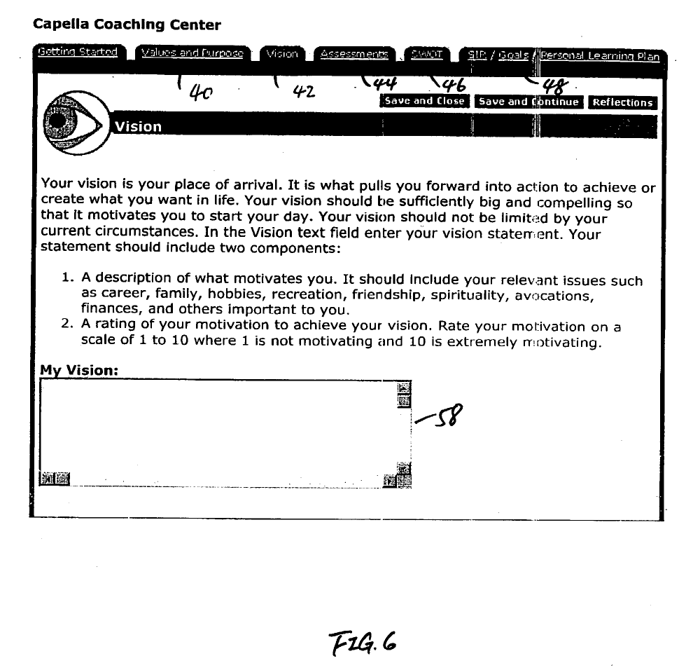

FIG. 6 is a screen view that illustrates the “Vision” web page. The “Vision” web page can be accessed through clicking the “Vision” tab 42 in the “Capella Coaching Center”. The learner can record a vision statement in the “Vision” text field 58. The vision statement generally includes two components. The first component is a description of what motivates the learner. It includes relevant issues such as career, family, hobbies, recreation, friendship, spirituality, avocations, finances, and other factors important to the learner. The second component is a rating of the learner's motivation to achieve his or her personal vision. It is easy to confuse the vision and the purpose. The vision is a destination that the learner is trying to reach, while the purpose is the direction or path that the learner takes to get to his or her vision. Purpose not only gives meaning to life, but also provides a coherence and focus for life.

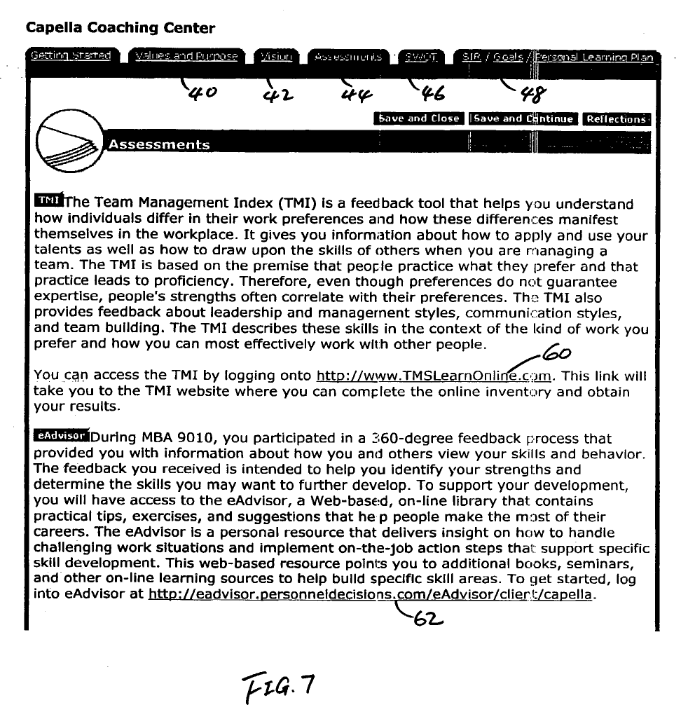

FIG. 7 is a screen view that illustrates the “Assessments” web page through which a learner can conduct self-assessments through use of the Team Management Index (TMI) by clicking the link 60. The TMI is a third party feedback tool provided by Team Management Systems. The “Assessments” web page can be accessed through clicking the “Assessments” tab in the “Capella Coaching Center”. The feedback tool helps the learner understand how individuals differ in their work preferences and how these differences manifest themselves in the workplace. It gives the learner information about how to use his or her talents and how to draw upon the skills of others when the learner is managing a team. The feedback tool also provides feedback about leadership and management styles, communication styles, and team building.

In addition, the learner can access an online library by clicking the link 62 on the “Assessments” web page. The online library contains practical tips, exercises, and suggestions that can help him or her make the most of his or her career. The online library is a personal resource that delivers insight on how to handle challenging work situations and implement on-the-job action steps that support specific skill development. The online library points the learner to additional books, seminars, and other online learning sources to help build specific skills.

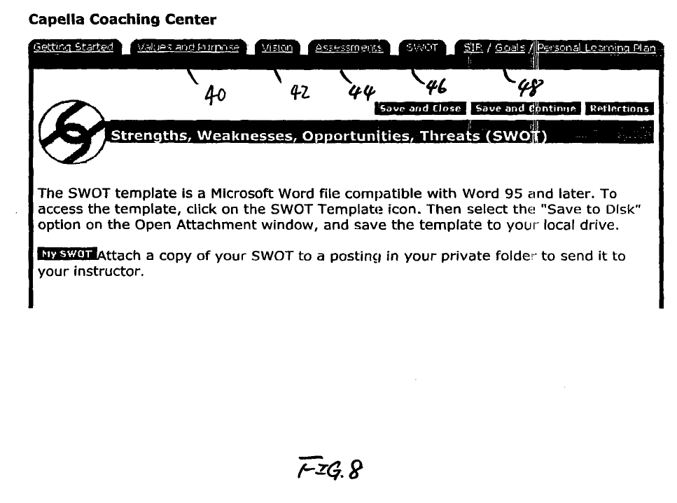

FIG. 8 is a screen view that illustrates a “SWOT” web page through which a learner can conduct an analysis on his or her strengths, weaknesses, opportunities, and threats. The “SWOT” web page can be accessed through clicking the “SWOT” tab 46 in the “Capella Coaching Center”. Through the SWOT analysis, the learner determines his or her position relative to his or her vision. The strengths are those characteristics that set the learner apart from other people and help the learner achieve his or her vision. The weaknesses, like the strengths, are related to the vision of the learner. The weaknesses are those areas that the learner wants and needs to improve, so that the learner can have the impact and influence to achieve his or her vision. The learner also identifies all of the opportunities, especially the career opportunities. The opportunities come either from the learner's company or from volunteer organizations. The learner evaluates and prioritizes the opportunities as they relate to his or her vision. Finally, the learner identifies the threats that hinder his or her ability to achieve his or her vision. Threats may be expectations or demands placed on the learner by his or her supervisor, project leader, or family members. Threats may also be events over which the learner has little control, such as the timing of a new project, unexpected business trips at work, or family illness or death. Being aware of the threats allows the learner to set goals for maximizing his or her opportunities and minimizing the threats that could keep him or her from moving forward in his or her life, career, and the MBA program.

After identifying his or her strengths, weaknesses, opportunities, and threats, the learner analyzes and prioritizes them. The issues that the learner raises as he or she works through the SWOT process will put him or her in a good position to develop specific and achievable goals for his or her MBA program and his or her vision.

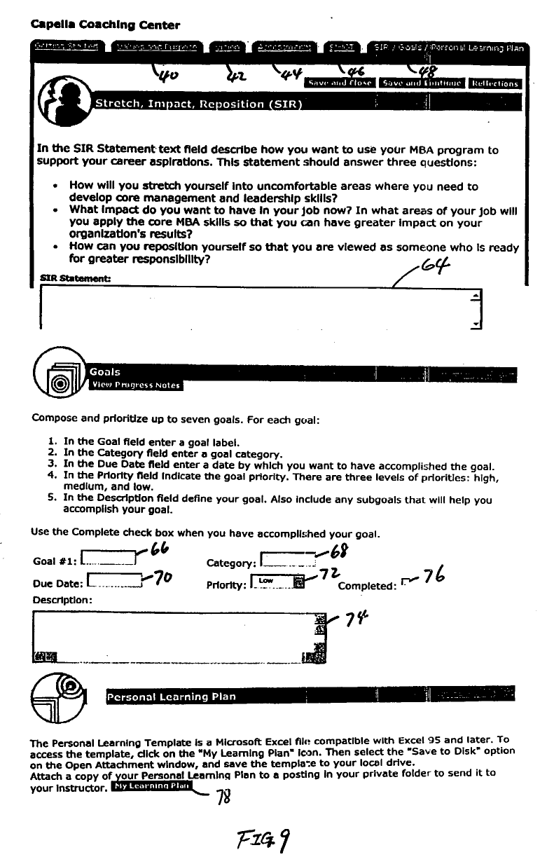

FIG. 9 is a screen view that illustrates the “SIR/Goals/Personal Learning Plan” web page through which a learner can record a statement of stretch, impact, and reposition, his or her personal goals, and a personal learning plan. The “SIR/Goals/Personal Learning Plan” web page can be accessed through clicking the “SIR/Goals/Personal Learning Plan” tab 48 in the “Capella Coaching Center”. The learner records the SIR statement in the “SIR Statement” text field 64. The SIR statement describes how the learner wants to use the MBA program to support his or her career aspirations. Stretch is an initial process that pushes the learner into uncomfortable areas where he or she develops core management and leadership skills. Impact is an intermediate process that focuses the application of the core MBA skills in the areas of the learner's job where the learner can have an impact on results. Reposition is a final process that helps learner reposition in the organization for greater responsibilities, so that the learner can advance in the career without being forced to look outside the organization for opportunities.

After completing the SIR statement, the learner can bring together what he or she has learned about himself or herself and develop a set of very specific goals. As shown in FIG. 9, the learner develops a set of goals that bridges the gap between where the learner is today, the immediate impact that he or she wants to have at work, and where he or she wants to be at the end of the MBA program. The goals address how to take advantage of the opportunities that the learner identified and how to overcome the barriers that threaten achievement of his or her vision and career aspirations.

The learner generally composes and prioritizes up to seven goals in the “Goals” section of the personal information web page. For each goal, the learner enters a brief and descriptive label in the “Goal” text field 66. Then the learner enters category information in the “Category” text field 68. The category information includes, but is not limited to, career, family, personal and professional development, spirituality, and avocation. In the “Due Date” text field 70, the learner identifies when he or she wants to have accomplished the goal. The learner then selects one of three goal priorities, namely, high, medium, and low in the “Priority” combo box. In the “Description” text field 74, the learner defines his or her goal and any sub-goals. After completing one of the goals during the remainder of the MBA program, the learner can return to this web page from any course web page and check off the “Completed” box 76. Each course web page contains a link to the personal information web pages. Preferably, the web page includes three or more sets of data entry fields containing the “Goal” text field, the “Category” text field, the “Due Date” text field, the “Priority” combo box, the “Description” text field, and the “Completed” box. It is important for the learner to acknowledge and record all of his or her personal goals.

Finally, the learner can determine how he or she wants to organize his or her course work. The learner decides when he or she wants to take the remainder of the courses in the MBA program in the “Personal Learning Plan” section as shown in FIG. 9. Generally, the Personal Learning Plan is a spreadsheet template. To access the template, the learner clicks on the “My Learning Plan” icon 78 to open a spreadsheet that lists the courses of the MBA program in the first column and the academic terms in the second row.

While taking courses in the MBA program, the learner can access the “Capella Coaching Center” when necessary to update his or her personal information as indicated in block 124 of FIG. 2. The learner can also update the SIR statement and goals as he or she further defines the values, purpose and vision. As stated above, each course web page contains a link to the personal information web pages.

It is noted that the personal information described above is documented in connection with the exemplary online MBA program offered by Capella University. For different academic programs, the personal information to be recorded may be different. The personal information generally relates to professional development in his or her career and/or study of the academic program. One of reasonable skill in the art will appreciate that the personal information web pages may be designed according to the requirements of the different academic programs and in connection with at least one of the online courses of the academic program.

As indicated in blocks 126 and 128 of FIG. 2, after successfully completing one or more courses (e.g., two foundation courses and one core course in the described embodiment),the learner can initiate the virtual coaching sessions. The professional coaching process is performed in parallel with the remainder of the courses of the MBA program to focus the MBA experience on individual career goals in the areas of stretch, impact, and reposition. Professional coaching is a process in which a learner and a professional coach work in partnership to identify and achieve professional goals of the learner. The professional coaching relationship is designed to help the learner take full advantage of his or her knowledge by stretching beyond expectations to improve performance in his or her job. The professional coaching relationship helps the learner apply what he or she has learned immediately and positions the learner to take on greater responsibility within his or her company or organization.

The roles and responsibilities of professional coaches can be different than those of academic advisors and faculty members. The academic advisors generally help the learners navigate through processes of the academic program and systems of the education institution. The academic advisors also help the learners resolve a dispute about disagreement over a course grade and find tutors who help the learner on course work. The faculty members generally respond to academic needs of the learner, provide instructions, facilitate discussions, and ensure the quality of teaching and learning.

In contrast, the professional coaches help the learner improve performance in the workplace, develop professional skills, clarify professional intentions, and build self-confidence in the workplace. The professional coaches also provide feedback that helps the learner prepare for new challenges and become a better problem solver and practitioner. In addition, the professional coaches not only help the learner leverage what the learner has learned into an accelerated career track, but also help the learner reposition himself or herself to achieve future career goals.

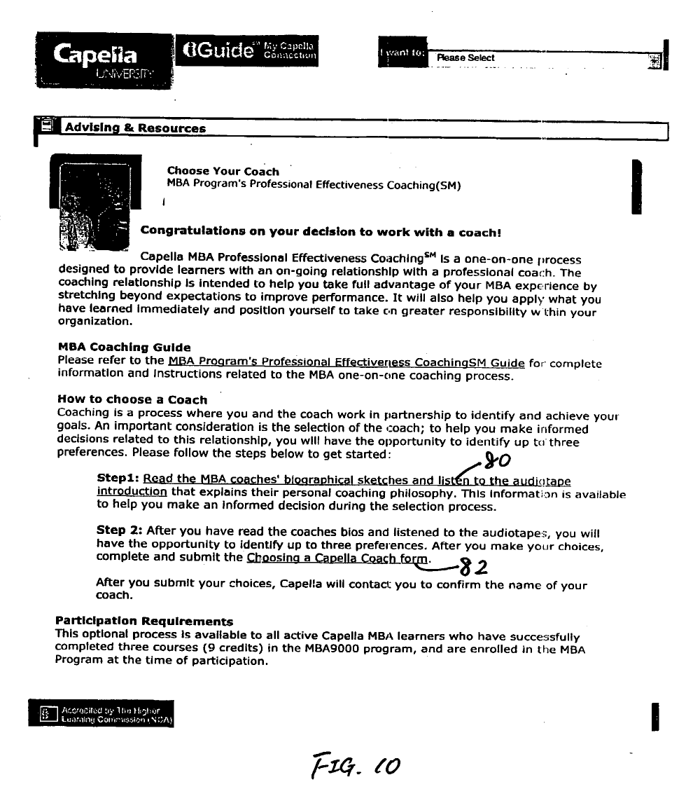

Selection of a professional coach is an important process of establishing the professional coaching relationship. From the “Coaching Center” main page as shown in FIG. 4a, the learner can access a “Choose Your Coach” web page by opening the link 37. FIG. 10 is a screen view that illustrates an example of a “Choose Your Coach” main page through which the learner can access coach biography web pages and choose a professional coach by clicking the links 80 and 82, respectively. As indicated in block 130 of FIG. 2, the learner reviews background information of available coaches online. Preferably, the learner browses the biographical information of the available coaches to identify one or more coaches with whom he or she is willing to work during the remainder of the MBA program.

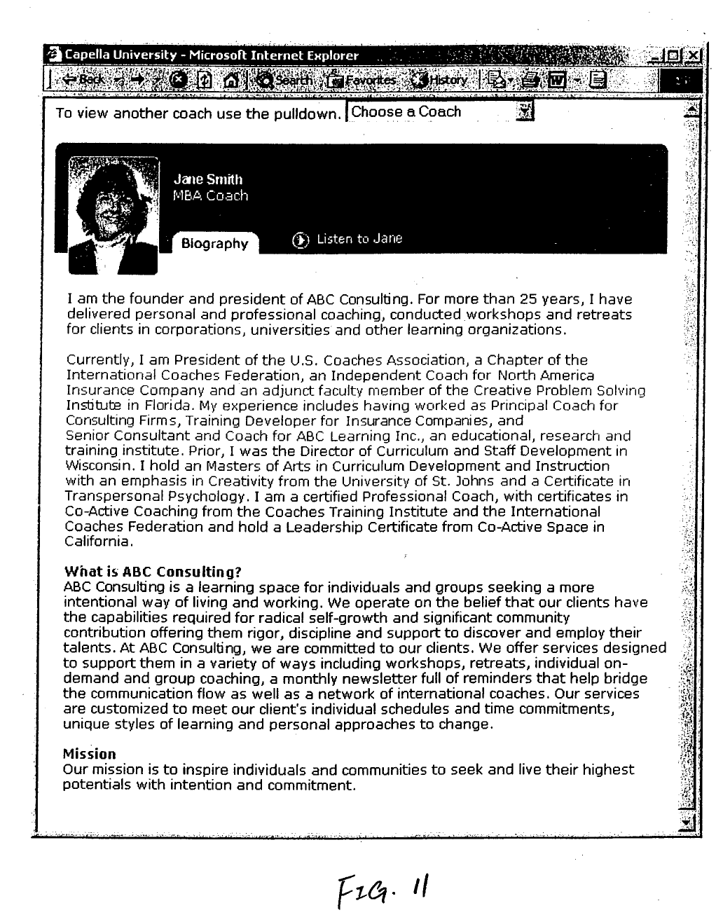

FIG. 11 is a screen view that illustrates an example of a coach biography page. The coach biography page preferably includes a digital picture, a resume, and a mission statement of the coach. Optionally, audio and/or video clips of the available coaches are also provided to the learner along with the biographical information. The learner can listen to the audio clips and/or watch the video clips of the available coaches online. As shown in FIG. 11, the audio clip can be listened to by opening the link 84 on the coach biography page.

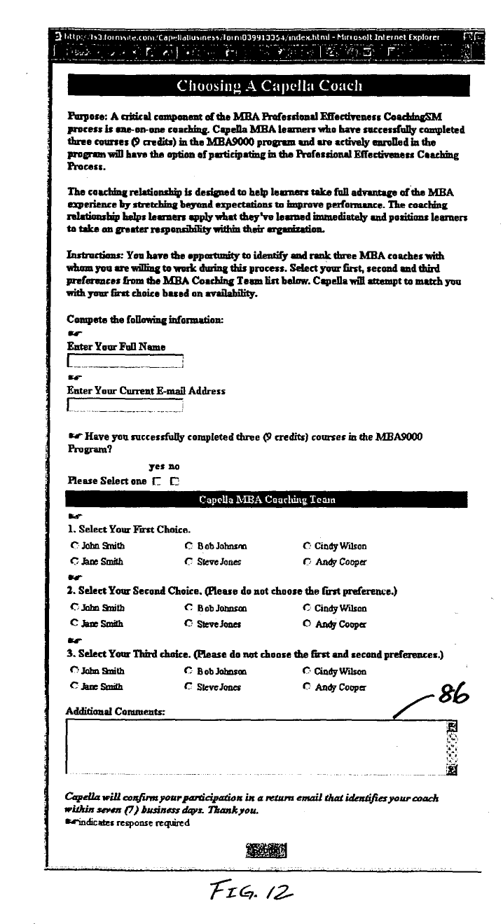

FIG. 12 is a screen view that illustrates an example of a web page through which a learner can choose a professional coach. The learner generally selects and ranks several (e.g., three) preferred coaches from a group of available coaches. After selecting and ranking preferred coaches, the learner submits the coach preferences to the administrative authority of the MBA program through use of the Internet-based communications as indicated in block 132 of FIG. 2. In addition, the learner can specify one or more communication tools to be used for the professional coaching as indicated in block 134 of FIG. 2. Preferably, the learner specifies the preferred communication tools in the “Additional Comments” text box 86. The communication tools include, but are not limited to, email, telephone, web phone, web board, online chat, etc. The coach and the learner will decide on the communication tools to be used in the virtual coaching sessions later.

After receiving the coach preferences submitted by the learner, the administrative authority then assigns a coach to the learner according to the coach preferences submitted by the learner and caseload of the preferred coaches. The coaching caseload can be managed either manually or by an automated matching process. Preferably, the administrative authority attempts to match the learner with the coach of the first choice. As indicated in block 136 of FIG. 2, the learner receives the decision from the administrative authority by email.

As indicated in block 138 of FIG. 2, some or all of the personal information of the learner will be shared with the assigned coach. The amount of information to be shared is determined by the learner. The assigned coach can only review the personal information that the learner has decided to share with the coach. The learner can either export the information from the personal information web pages or cut and paste it into a word processing document and send it to the coach via email. Since confidentiality is important to the coaching relationship, rules are established between the assigned coach and the learner at the start of the engagement in order to establish an open and trusting relationship between the coach and the learner.

As indicated in block 140 of FIG. 2, the learner and the assigned coach preferably reach a coaching agreement through use of the Internet-based communications or telephone. The coaching agreement can be either formal or informal. Generally, the administrative authority provides the coach with a standard coaching agreement that describes the conditions of the coaching relationship. The learner is expected to complete an electronic questionnaire about the coaching experience with the assigned coach. The learner and the assigned coach will develop a coaching agreement including how and when the learner and the assigned coach communicate with each other. Particularly, the learner and the coach decide on one or more communication tools to be used during the virtual coaching sessions. In addition, the coaching agreement may include rules of the engagement. The final coaching agreement can be mailed or submitted to the administrative authority through use of the Internet-based communications.

After the final coaching agreement is reached, the assigned coach begins to work with the learner to create a professional development plan specific to the coaching relationship. In particular, the learner and the assigned coach will discuss the personal information that the learner recorded in the personal information web pages, which includes the information regarding professional development and the learning plan of the MBA program. The professional development plan reflects the desire of the learner for professional growth in targeted areas. The professional development plan also serves as a guide for further discussion between the learner and the assigned coach. As indicated in block 142 of FIG. 2, the learner and the coach work together to create the plan through use of the Internet-based communications or phone conversations. The professional development plan can be modified throughout the coaching relationship.

After reviewing the professional development plan, the learner will schedule virtual coaching sessions with the assigned coach as indicated in block 144 of FIG. 2. Preferably, the coaching appointments are scheduled via an online interactive coaching calendar. Optionally, the coaching appointments can be scheduled via other communication tools including, but not limited to, email, telephone, web phone, web board, online chat, etc.

As indicated in block 146 of FIG. 2, the learner will preferably participate in at least one virtual coaching session with the assigned coach in at least one academic term during the academic program. As used herein, the phrase “academic term” refers to a segment of an academic year, including, but not limited to, semester, trimester, or quarter. Preferably, the virtual coaching session is a one-on-one virtual meeting according to the agreement held during each academic term throughout the entire academic program. The learner who enrolls in the online MBA program offered by Capella University generally participates in one virtual coaching session each quarter throughout the remainder of the program. The virtual meeting is conducted by using one or more of the communication tools that the learner and the assigned coach agreed upon.

Before the scheduled virtual coaching session, the learner and the assigned coach preferably prepare for the meeting, so as to maximize the effectiveness of the time used. Specifically, the learner makes notes, jots down questions, and reviews pertinent documents such as the personal learning plan, prior to the virtual coaching session.

The learner may submit feedback to the administrative authority during each academic term through use of the Internet-based communications. The feedback not only helps the administrative authority examine the effectiveness of the professional coaching, but also helps the administrative authority improve the quality of the professional coaching.

The quality of the coaching relationship is essential to the overall success of the learner. If a learner feels that the coaching relationship is not working during an academic term, the learner will have the option of changing the assigned coach at the end of the academic term by submitting a request to the administrative authority through use of the Internet-based communications.

### EXAMPLE

David is the call center manager in Macon, Ga. He is ambitious and has decided to pursue an MBA degree through Capella University's online MBA program. David is unsure what he wants to do after he completes his MBA. He would like to stay with the company. However, he wants greater responsibility and influence in the company than he has in the call center. David was intrigued by the professional coaching component of Capella University's MBA program. He hopes the professional coaching can help him identify a more promising career path.

With the email confirming his registration in the first foundation course of the MBA program, David receives his user name and password for his course. Once logged into his course, David can access his personal information web pages, which provides a way for him to record his learning and insights as he works through his professional development. The personal information web pages provide sections for David to:

Record his personal values and purpose;

Record his vision statement;

Access the Team Management Index (TMI) feedback tool;

Record his statement that outlines how he plans to stretch himself, have impact on his job, and reposition himself for greater influence and responsibility during his MBA program;

Record his goals and a timeline for achieving them; and

Outline his learning plan for the remainder of his MBA program.

He checks out the personal information web pages during his first week in the program and works on the various components throughout his first course. He will be able to access and update his personal information web pages throughout the remainder of the MBA program as he finds that his goals have changed or he has additional insight into his values, vision, and purpose.

David realizes that he knows little about his needs and preferences. He is pleased that, as part of his first course, he will be able to use the TMI feedback tool, which will help him understand how individuals differ in their work preferences and how these differences manifest themselves in the workplace. The TMI also provides feedback about leadership and management styles, communication styles, and team building. In addition to the TMI tool, David will also participate in a feedback process that will provide him with information about how he and others view his skills and behaviors. The feedback he receives is intended to help him identify his strengths and determine the skills he may want to further develop. To support his development, he has accessed an online library that contains practical tips, exercises, and suggestions that will help him make the most of his career.

David realizes that part of his frustration with the call center is that so many customer problems result from decisions made in the manufacturing process. David becomes aware that his energy level rises and he gets passionate when he talks about bringing a customer-focus to the manufacturing side of the company. He realizes that he would really like to be a plant manager. In fact, he would like to manage the plant in Centerville, so that he could be closer to his family.

After completing two foundation courses and one core course, David decides to select a professional coach. The coaching relationship is intended to help him take full advantage of his MBA experience by stretching beyond expectations to improve performance. It will also help him apply what he has learned immediately and position himself to take on greater responsibility within his organization. David selects his professional coach with the aid of biographical information and audio clips from each professional coach that explain his or her personal coaching philosophy. After reviewing the biographical information, David identifies and submits his top three preferences to the administrative authority, and he receives confirmation from the administrative authority with the name of his coach.

With the help of the coach, David develops a strategy to realize his goals. His classmates encourage him to take a leadership role in the class on the operations project. His coach helps him identify individuals within the company with whom he can explore his interest in the operations. These individuals are excited about working with David because of his knowledge of customer problems.

David and the quality manager at the Centerville plant together develop a process that addresses a particularly vexing problem that many customers have. The result is a 34 percent drop in customer complaints and an 83 percent drop in product returns for this problem. Now the quality manager is looking for a way to bring David to his team.

All patents and patent applications disclosed herein, including those disclosed in the background of the invention, are hereby incorporated by reference. Although the present invention has been described with reference to preferred embodiments, workers skilled in the art will recognize that changes may be made in form and detail without departing from the spirit and scope of the invention. In addition, the invention is not to be taken as limited to all of the details thereof as modifications and variations thereof may be made without departing from the spirit or scope of the invention.

I claim:

1. A method for a learner to obtain professional coaching in connection with an online academic program, the method comprising the steps of:
(a) recording personal information of the learner in a personal information web page;
(b) establishing a professional coaching relationship through use of the Internet-based communications; and
(c) participating in one or more virtual coaching sessions during the online academic program.

2. The method of claim 1 wherein step (a) includes recording the personal information relating to professional development of the learner in the personal information web page.

3. The method of claim 1 wherein step (a) includes recording the personal information relating to study of the academic program in the personal information web page.

4. The method of claim 1 further comprising starting one or more online courses in the academic program prior to step (a).

5. The method of claim 4 wherein step (a) is performed in connection with at least one of the online courses in the academic program.

6. The method of claim 1 and further comprising updating the personal information of the learner in the personal information web page while taking online courses in the academic program after step (a).

7. The method of claim 1 wherein step (b) includes the steps of:
(i) reviewing background information of available coaches online;
(ii) submitting coach preferences to an administrative authority of the academic program through use of the Internet-based communications;
(iii) receiving contact information of a coach assigned to the learner by the administrative authority;
(iv) sharing the personal information of the learner with the assigned coach through use of the Internet-based communications;
(v) scheduling one or more coaching appointments for the virtual coaching sessions with the assigned coach.

8. The method of claim 7 wherein step (i) includes reviewing biographical information of the available coaches online.

9. The method of claim 7 wherein step (i) includes watching video clips of the available coaches online.

10. The method of claim 7 wherein step (i) includes listening to audio clips of the available coaches online.

11. The method of claim 7 wherein step (ii) includes selecting one or more preferred coaches from the available coaches online.

12. The method of claim 7 further comprising selecting one or more communication tools for the professional coaching after step (ii).

13. The method of claim 12 wherein the step of selecting one or more communication tools includes selecting one or more communication tools from a group of communication tools comprising email, telephone, web phone, online chat, and web board.

14. The method of claim 7 wherein the coach is assigned to the learner according to the coach preferences submitted by the learner and caseload of the preferred coaches.

15. The method of claim 7 further comprising reaching a coaching agreement with the assigned coach after step (iv) and prior to step (v).

16. The method of claim 15 wherein the step of reaching a coaching agreement with the assigned coach includes the steps of:
developing the coaching agreement with the assigned coach;
finalizing the coaching agreement; and
submitting the finalized coaching agreement to the administrative authority through use of the Internet-based communications.

17. The method of claim 7 further comprising receiving a professional development plan co-created by the assigned coach and the learner through use of the Internet-based communications after step (iv) and prior to step (v).

18. The method of claim 7 wherein step (v) includes scheduling the coaching appointments with the assigned coach via an online interactive coaching calendar.

19. The method of claim 1 wherein step (c) includes participating in at least one virtual coaching session in at least one academic term during the academic program.

20. The method of claim 1 wherein step (c) includes using one or more communication tools comprising email, telephone, web phone, online chat, and web board.

21. A method for providing professional coaching to a learner in connection with an online academic program, the method comprising the steps of:
(a) providing course web pages in connection with the online academic program;
(b) providing links in the course web pages to a personal information web page for the learner to record personal information;
(c) receiving personal information that the learner records in the personal information web page through use of Internet-based communications;
(d) assisting the learner to establish a professional coaching relationship through use of the Internet-based communications; and
(e) providing one or more virtual coaching sessions to the learner during the academic program.

22. The method of claim 21 wherein the personal information includes information relating to professional development of the learner.

23. The method of claim 21 wherein the personal information includes information relating to study of the online academic program.

24. The method of claim 21 further comprising enrolling the learner in one or more online courses in the academic program prior to step (c) and after step (b).

25. The method of claim 24 wherein step (c) is performed in connection with at least one of the online courses in the academic program.

26. The method of claim 21 further comprising receiving updated personal information from the learner through use of the Internet-based communications while the learner is taking online courses in the academic program after step (c).

27. The method of claim 21 wherein step (d) includes the steps of:
(i) providing background information of available coaches to the learner online;
(ii) receiving coach preferences submitted by the learner through use of the Internet-based communications;
(iii) assigning a coach to the learner;
(iv) sharing the personal information of the learner with the assigned coach through use of the Internet-based communications; and
(v) providing an online tool to the learner for scheduling one or more coaching appointments for the virtual coaching sessions with the assigned coach.

28. The method of claim 27 wherein step (i) includes providing biographical information of the available coaches to the learner online.

29. The method of claim 27 wherein step (i) includes providing video clips of the available coaches to the learner online.

30. The method of claim 27 wherein step (i) includes providing audio clips of the available coaches to the learner online.

31. The method of claim 27 further comprising receiving a selection of one or more communication tools for the professional coaching from the learner through use of the Internet-based communications after step (ii).

32. The method of claim 31 wherein the step of receiving a selection of one or more communication tools includes receiving the selection of one or more communication tools from a group of communication tools comprising email, telephone, web phone, online chat, and web board.

33. The method of claim 27 wherein step (iii) includes assigning the coach to the learner according to the coach preferences submitted by the learner and caseload of the preferred coaches.

34. The method of claim 27 further comprising assisting the learner to reach a coaching agreement with the assigned coach after step (iv) and prior to step (v).

35. The method of claim 34 wherein the step of assisting the learner to reach a coaching agreement with the assigned coach includes the steps of:
providing the coach with a standard coaching agreement describing conditions of the coaching relationship; and
receiving a finalized coaching agreement through use of the Internet-based communications.

36. The method of claim 27 further comprising providing a professional development plan co-created by the learner and the assigned coach to the leaner through use of the Internet-based communications after step (iv) and prior to step (v).

37. The method of claim 27 wherein step (v) includes providing an online interactive coaching calendar for the learner to schedule the coaching appointments with the assigned coach.

38. The method of claim 21 wherein step (e) includes providing at least one virtual coaching session to the learner in at least one academic term during the academic program.

39. The method of claim 21 wherein step (e) includes providing one or more communication tools comprising email, telephone, web phone, online chat, and web board.
